(19) United States
(12) Patent Application Publication
(10) Pub. No.: US 2003/0074226 A1
(43) Pub. Date: Apr. 17, 2003

(54) Actuarial data processing system and an actuarial method

(76) Inventors: Chris Rostron, Wimborne (GB); William Nicholas Anderton, Guildford (GB)

Correspondence Address: Roberts Abokhair & Mardula, LLC, 11800 Sunrise Drive, Suite 1000, Reston, VA, 20191-5302, US

(21) Appl. No.: 09/977,572

(22) Filed: Oct. 15, 2001

(51) Int. Cl. G06F 17/60

(52) U.S. Cl. 705/3

(57) ABSTRACT

An actuarial data processing system comprises data input means for inputting client information, output means for outputting information, storage means and processing means. The processing means is adapted to use the client information and data stored in the storage means to output the client's life expectancy.

### FIELD OF THE INVENTION

This invention relates generally to an actuarial data processing system and to an actuarial method.

### BACKGROUND OF THE INVENTION

The application of premium formulae to mortality rates is normal actuarial practice. Mortality tables are generally constructed based simply on the fact that the mortality, or risk of death, of individuals, both male and female, increases with age. Mortality tables are constructed based on the available research statistics relating to the type of population under measurement. Examples include tables of life assured mortality and tables of general population mortality.

These tables do not generally take into account specific life impairments or the quality of life in individuals. To do so demands a unique approach, recognising that, for certain individuals, their impairments and quality of life have a direct bearing on their expectation of life which is not reflected appropriately in the existing standard mortality tables.

### SUMMARY OF THE INVENTION

It is therefore an object of the present invention to provide a more comprehensive approach for constructing mortality tables to take into individual factors such as particular impairments, other risks and quality of life.

The present invention provides a system and a method for the determination of premium tables to produce annuity rates, wherein specific life impairments and quality of life factors are specifically factored into the determination.

### BRIEF DESCRIPTION OF THE SYSTEM

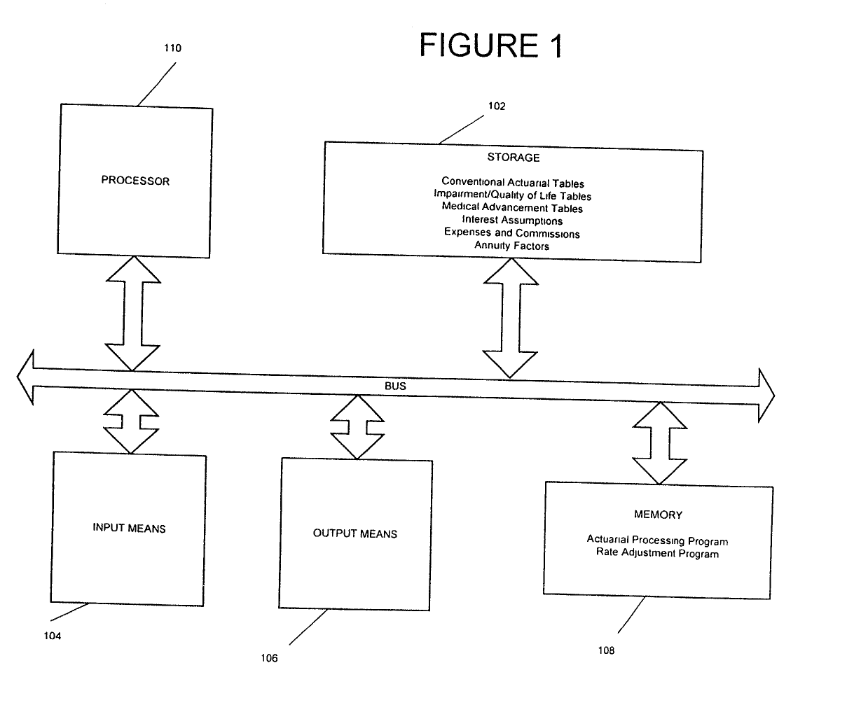

FIG. 1 is an overview of the system;

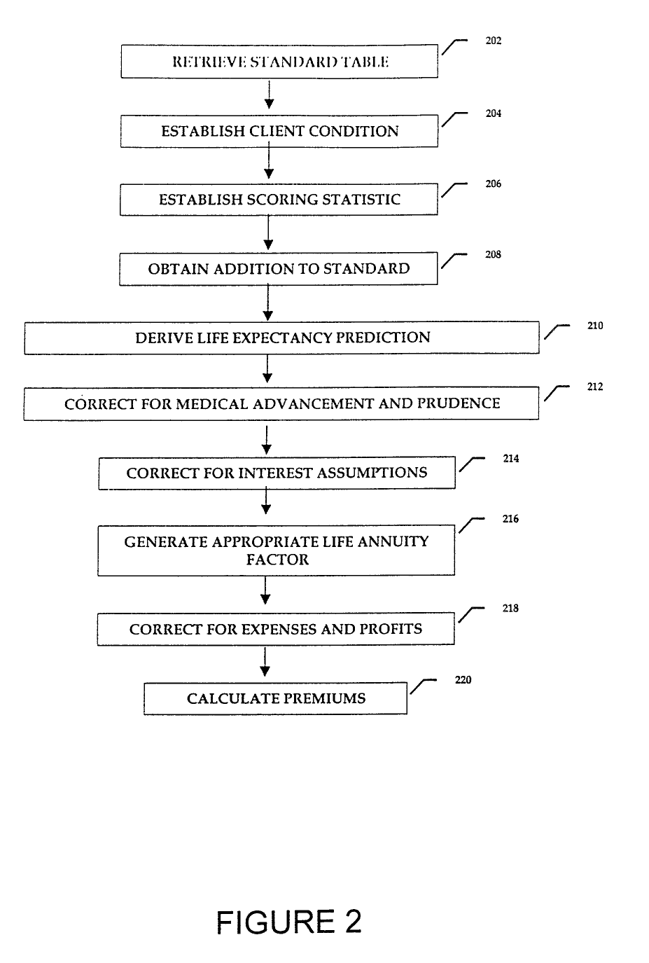

FIG. 2 is a flow chart depicting the process of an embodiment of the present invention;

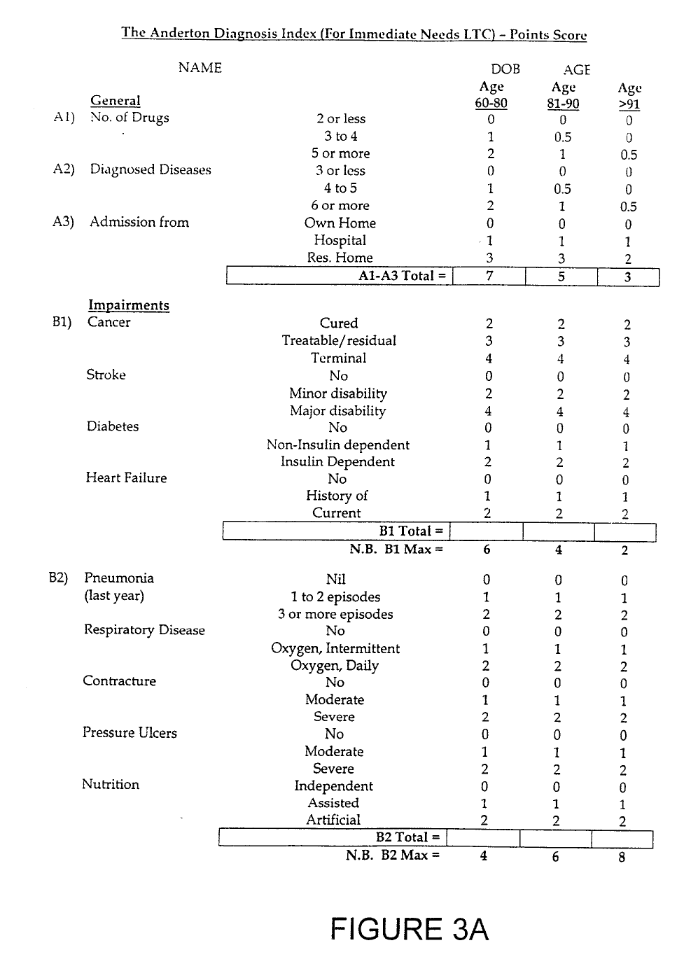

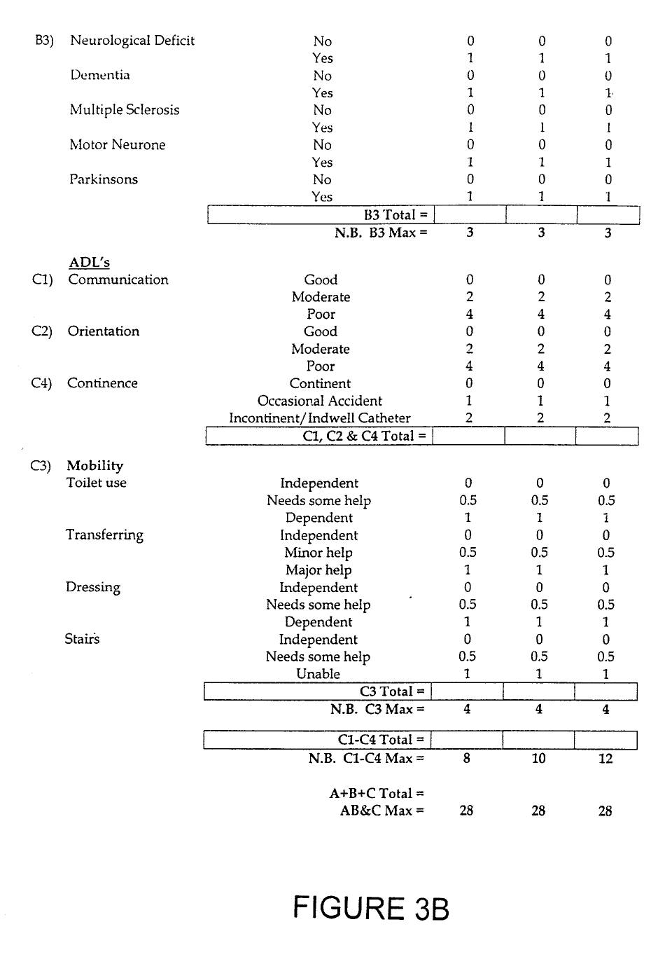

FIGS. 3(a) and 3(b) show the scoring statistic evaluation;

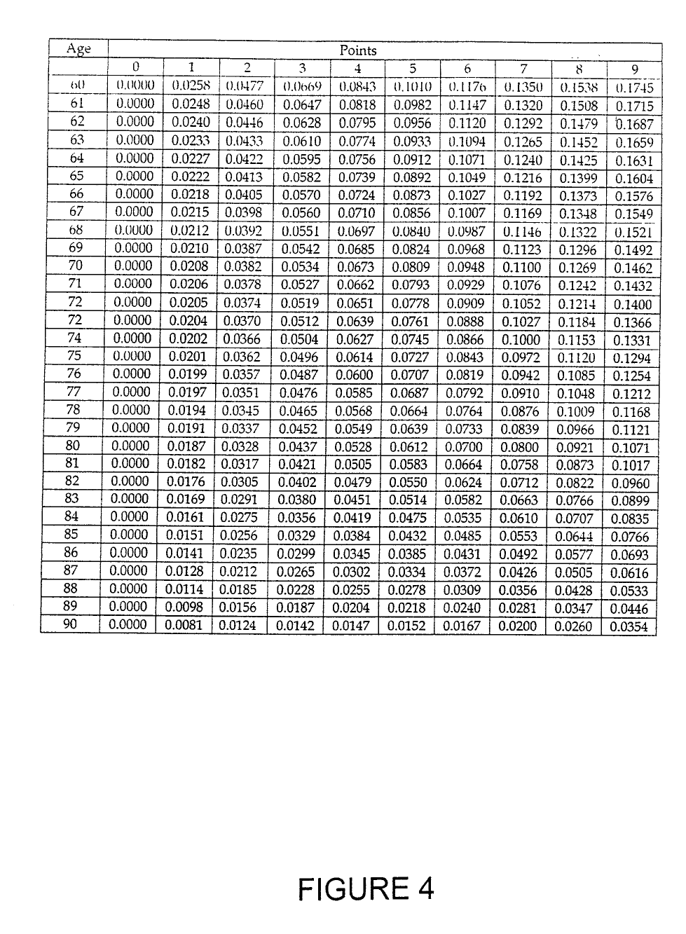

FIG. 4 depicts a two-dimensional table representing factors of addition to standard mortality tables that allow for impairments and quality of life factors to be taken into account;

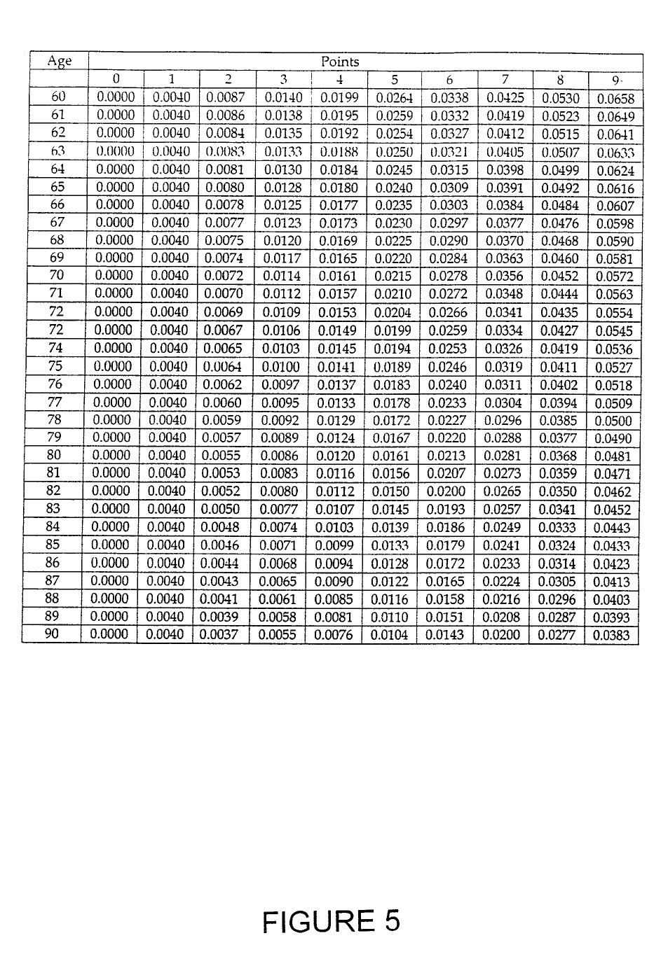

FIG. 5 depicts the two-dimensional table of FIG. 4 corrected for medical/social advances and prudence.

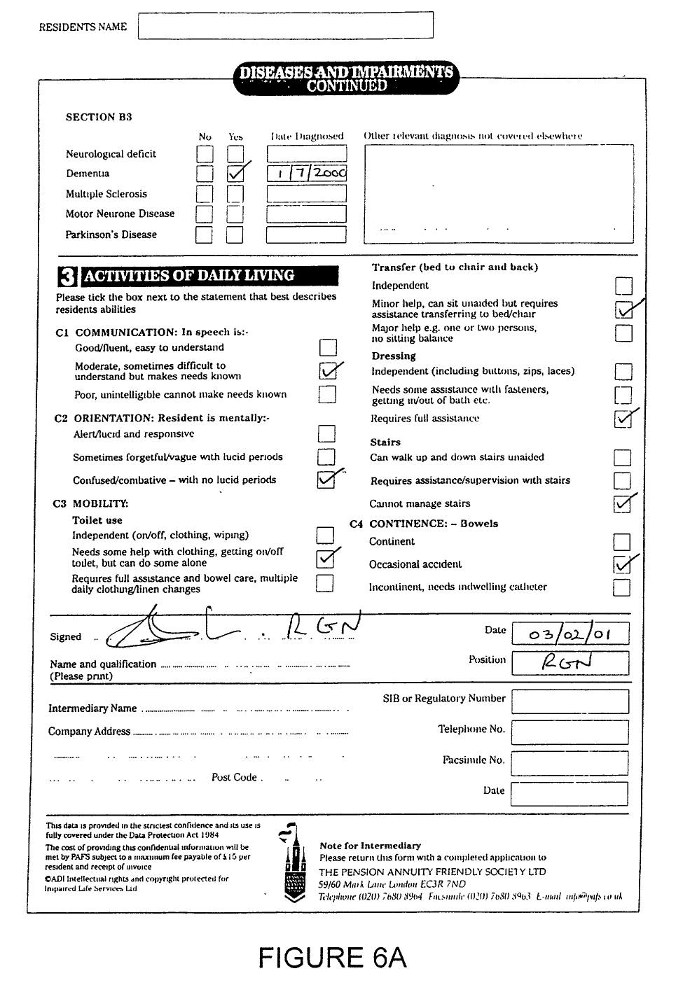

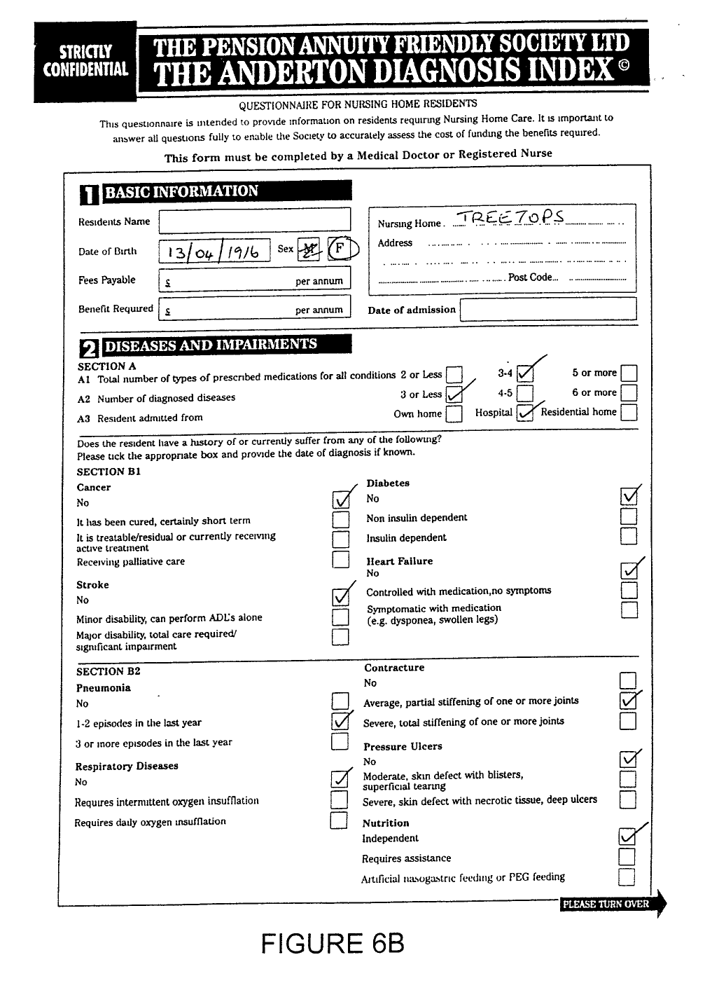

FIGS. 6a and 6b depict a client questionnaire, and

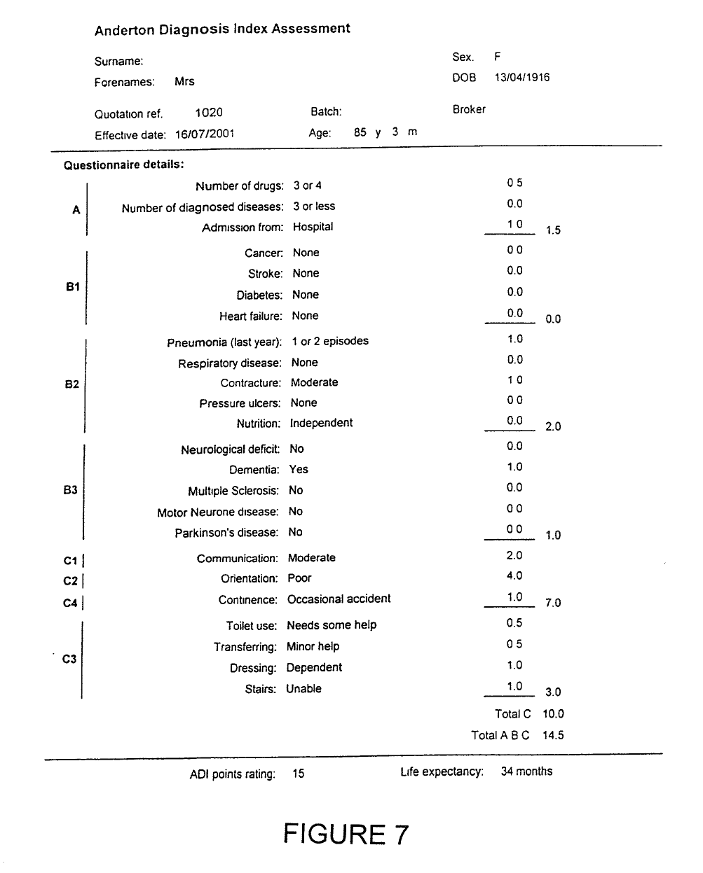

FIG. 7 depicts the establishment of a scoring statistic for the client questionnaire of FIGS. 6a and 6b.

### DETAILED DESCRIPTION OF THE PREFERRED EMBODIMENT

A block diagram of the system is shown in FIG. 1.

The method of the present invention is executable on a computer with an operating system, that includes a central processing unit (CPU), mains storage 102, input and output resources, user interface or input means 104 and data output means 106. A standard IBM compatible PC or other computer comprising a CPU, such as the Intel 80486, or Pentium processor with RAM in which instructions may be stored together with hard disk storage of the various data required for implementation of the present invention, is a satisfactory platform on which to establish the system and method of the present invention. Data accessible through the computer includes but is not limited to conventional actuarial tables, life expectancy prediction tables, medical advancement tables, interest assumptions, expenses and commissions, and annuity factors. The CPU has a memory 108 storing processor-readable code and a processor 110 for implementing that code. Programs stored in, and accessible through, the computer include but are not limited to rate adjustment means such as a multiple of standard mortality, age rate-up and constant extra deaths. Examples of input means 104 include a keyboard, mouse, touch pad, voice recognition system or any other means that allow choices on a screen to be selected. Examples of output means 106 include a printer or video monitor, or electronic transmission to a second source or any other means that permit visual display or generation of hard copy output.

The main steps of the method of an embodiment of the present invention are shown in FIG. 2.

A conventional actuarial table is first retrieved at 202. The client's medical conditions and/or impact of quality of life factors are then established at 204 by completion of a questionnaire. The questionnaire may be completed manually and the data from the questionnaire input into the computer, or the questionnaire may be filled out directly at the computer. Alternatively, the questionnaire can be filled out remotely and sent via the Internet or any other communications network to the computer. A client scoring statistic is then determined at 206 and applied to a bi-variate age-points table (see FIGS. 4 and 5) to select an appropriate addition factor at 208. The bi-variate age-points table is derived from data relating to deaths in nursing homes, and in particular from data relating to the date of death of various patients, their date of admission, date of notification of their relevant illness, sex, appropriate ICD9 cause code, primary and secondary description of the cause and the length of stay in the home. The data was compiled using three curve-fitting techniques to determine a series of addition factors for various degrees of impairment and disablement. In a preferred embodiment of the invention the tables also incorporate adjustments for profit margins and prudence based on experience data. For example, the table of FIG. 5 incorporates adjustments for prudence and medical and social advances.

In an alternative embodiment of the invention the steps 202 and 204 are reversed, i.e. a client condition is established and analysed before standard actuarial tables are consulted.

The addition factor is added to the appropriate probablity factors from a standard mortality table, for example, P(M/F)A80C10 tables provided by the Institute and Faculty of Actuaries in the UK. The life expectancy prediction (LEP) is then derived at 210. The LEP is derived from the standard actuarial equation for life expectancy of a life aged x viz-

$$e = {\sum }_{t = 0}^{∞} tpx \qquad Equation I$$

where the values of tpx are derived from the recurrence relation

tpx=t−1px.(1−q(x,M/F,t)−k(x,M/F,s);opx=1-Equation II

The factors q(x,M/F,t) are the probabilities of death at age x+t for the appropriate sex taken from a standard mortality table and the values of k(x,M/F,s) represent the addition factor based on impairment and quality of life yielding a scoring statistic of s for a life aged x for the appropriate sex. Equation I is modified suitably where the benefits under the policy are paid more frequently than yearly.

FIGS. 3(a) and 3(b) together detail the assessment of the scoring statistic.

FIG. 4 shows an example table of addition factors for males ages 60 through 90 for scoring statistic ten through nineteen.

Returning to FIG. 2, following the application of the equations, calculated values are corrected for medical and/or social advances at 212. Deductions are made from the addition factors for premium calculation purposes. Alternatively, the addition factors can be pre-manipulated to take account of medical and social advances, or any other relevant factors, before application of the equations. For example, FIG. 5 shows an example table of addition factors for males ages 60 through 90 for scoring statistic ten through nineteen, wherein the values have been corrected for medical/social advances and prudence.

Returning again to FIG. 2, a correction for interest assumptions is then made at 214. This value can vary and is responsive to multiple factors. In a preferred embodiment, a uniform net assumption of a selected percent per annum allows an entity to seek its competitive advantage and its profits from the selection and rating of its life risks, rather than from making an investment spread. This approach provides an investment assumption that is both straightforward and sufficiently conservative to avoid the need for adjustment in response to each shift in the shape or level of the yield curve. However, in other circumstances, alternatives such as a separate interest rate assumption for each life expectancy prediction may be preferred. Again, it is possible to incorporate interest rate assumptions into the addition factors prior to the application of the equations.

Once the mortality and interest bases are specified, tables of single life annuity factors 216 for each age at entry, and various scoring statistics can be produced.

Returning to FIG. 2, it is also desired to correct for expenses and profits associated with brokering and marketing at step 218. For example, the user may wish to include expense commission and profit loadings such as brokerage, marketing allowance, initial expenses, profit loading and payment expenses in the gross premium bases. In a preferred embodiment prices and reserves for expenses will be set on the pessimistic assumption that sub-economic volumes will be written and that business will then be run off. In this anticipated scenario the expense allowance is expected to be a substantial source of profit. Again, correction for expenses and profits can be carried out on the addition factors before the equations are applied.

The final step is the calculation of the premiums 220 using the calculated and corrected life expectancy prediction.

The example of FIGS. 6a, 6b and 7 shows:

a) The establishment of the client condition by way of a standard proposal form (FIGS. 6a and 6b), and

b) The establishment of the scoring statistic (FIG. 7) which leads, in the case shown, to a single premium of US$104,769 providing a benefit of US$30,000 per annum payable monthly in advance.

In the example a female aged 85 is analysed by completing the questionnaire. A total scoring statistic of 15 is obtained and the bi-variate age-points table FIG. 4 is consulted. The corresponding addition factor from the table is 0.1928. This addition factor is combined with data from a standard mortality table, for example, a P(M/F)A80C10 table provided by the Institute and Faculty of Actuaries in the UK. The appropriate q factors from the standard actuarial table for an 85-year old female are 0.082696, 0.091305, 0.100325, 0.109694 and 0.119343. Using the equation above, the life expectancy prediction is calculated from the following:

$$\begin{matrix}0 px = 1 & \\ 1 px = 1 ( 1 - 0.082696 - 0.1928 ) & = 0.724504 \\ 2 px = 0.724504 ( 1 - 0.091305 - 0.1928 ) & = 0.518669 \\ 3 px = 0.518669 ( 1 - 0.100325 - 0.1928 ) & = 0.366634 \\ 4 px = 0.366634 ( 1 - 0.109694 - 0.1928 ) & = 0.255729 \\ 5 px = 0.255729 ( 1 - 0.119343 - 0.1928 ) & = 0.175905\end{matrix}$$

This process is repeated to the end of the life table. The individual results are then summed to produce the life expectancy prediction. This life expectancy prediction can then be adjusted to permit the frequency and mode of payment of annuity installments to be taken into account. An appropriate premium can subsequently be calculated. The premium can be calculated within the system. However, as an alternative, the system can merely output the life expectancy prediction, so that the premium can be calculated independently.

It will be appreciated that the code required to implement the method of the invention can be stored on a carrier medium.

1. An actuarial data processing system comprising data input means for inputting client information, output means for outputting information, storage means and processing means, wherein the processing means is adapted to use the client information and data stored in the storage means to produce a scoring statistic representative of the client's level of health, and to use the scoring statistic to produce and output a value representative of client life expectancy.

2. An actuarial data processing system as claimed in claim 1, wherein standard actuarial data is stored in the storage means.

3. An actuarial data processing system as claimed in claim 1 or claim 2, wherein medical advancement data is additionally stored in the storage means.

4. An actuarial data processing system as claimed in any one of the preceding claims, wherein prudence correction data is additionally stored in the storage means.

5. An actuarial data processing system as claimed in any one of the preceding claims, wherein interest data is additionally stored in the storage means.

6. An actuarial data processing system as claimed in any one of the preceding claims, wherein expenses and expected profits data is additionally stored in the storage means.

7. An actuarial data processing system as claimed in any one of the preceding claims, wherein annuity factors are additionally stored in the storage means.

8. An actuarial data processing system as claimed in any one of the preceding claims, wherein the processing means is additionally adapted to calculate a premium.

9. An actuarial data processing system as claimed in any one of the preceding claims, wherein the processing means is adapted to make an adjustment for medical advances and prudence.

10. An actuarial data processing system as claimed in any one of the preceding claims, wherein the processing means is adapted to make an adjustment for interest assumptions.

11. An actuarial data processing system as claimed in any one of the preceding claims, wherein the processing means is adapted to make an adjustment to take account of expenses and profits.

12. An actuarial data processing system as claimed in any one of the preceding claims, wherein the processing means is adapted to operate the following process
$$e = {\sum }_{t = 0}^{∞} tpx$$
wherein
tpx=t−px.1(1−q(x,M/F,t)−k(x,M/F,s);opx=1,
and q(x,M/F,t) is the probability of death at age x+t for the appropriate sex and k(x,M/F,s) represents an addition factor based on impairment and quality of life yielding a scoring statistic of s for a life aged x for the appropriate sex.

13. An actuarial method comprising assigning a statistic to a client based on the client's level of health, deriving data from a standard actuarial table, and producing a value representative of the client life expectancy using the statistic and the derived data.

14. An actuarial method comprising assigning a statistic to a client based on the client's level of health, deriving data from a standard actuarial table, producing a value representative of the client life expectancy using the statistic and the derived data, and using the value produced to calculate a premium.

15. An actuarial method as claimed in claim 13 or 14, further comprising making an adjustment to take account of medical advances and prudence.

16. An actuarial method as claimed in any one of claims 13 to 15, further comprising making an adjustment for interest assumptions.

17. An actuarial method as claimed in any one of claims 13 to 16, further comprising making an adjustment to take account of expenses and expected profits.

18. An actuarial method as claimed in any one of claims 13 to 17, further comprising calculating annuity factors.

19. An actuarial method as claimed in any one of claims 13 to 18, wherein the annuity factors are incorporated into the value prior to calculation of the premiums.

20. An actuarial method as claimed in any one of claims 13 to 19, wherein the value is calculated using
$$e = {\sum }_{t = 0}^{∞} tpx$$
wherein
tpx=t−1px.(1−q(x,M/F,t)−k(x,M/F,s);opx=1,
and q(x,M/F,t) is the probability of death at age x+t for the appropriate sex and k(x,M/F,s) represents an addition factor based on impairment and quality of life yielding a statistic of s for a life aged x for the appropriate sex.

21. An actuarial data processing system for carrying out an actuarial method comprising a memory storing processor readable code;
and a processor for reading and implementing the code in the memory, wherein the processor readable code comprises code for controlling the processor to be configured as the processing system of any one of claims 1 to 12.

22. An actuarial data processing system for carrying out an actuarial method comprising a memory storing processor readable code;
and a processor for reading and implementing the code in the memory, wherein the processor readable code comprises code for controlling the processor to implement the method of any one of claims 13 to 20.

23. A carrier medium carrying computer readable code for controlling a computer to be configured as the processing system of claims 1 to 12.

24. A carrier medium carrying computer readable code for controlling a computer to implement the method of claims 13 to 20.

25. A computer system for processing actuarial data, comprising a data store storing data on a client's level of health, and standard actuarial table data; and
a processor programmed to assign a statistic based on the client's level of health stored in the data store, to derive data using the standard actuarial table data in the data store, and to produce a value representative of the client's life expectancy using the statistic and the derived data.
